(19) United States
(12) Patent Application Publication
(10) Pub. No.: US 2025/0287025 A1
(43) Pub. Date: Sep. 11, 2025

(54) METHOD, APPARATUS, DEVICE AND STORAGE MEDIUM FOR VIDEO TRANSCODING

(71) Applicant: Beijing Zitiao Network Technology Co., Ltd., Beijing (CN)

(72) Inventors: Ti GONG, Beijing (CN); Bin WANG, Beijing (CN)

(21) Appl. No.: 18/860,598

(22) PCT Filed: May 9, 2023
(86) PCT No.: PCT/CN2023/092870

§ 371 Date: Oct. 25, 2024

(30) Foreign Application Priority Data
May 24, 2022 (CN) 202210572191.3

(51) Int. Cl. H04N 19/40; H04N 19/149

(52) U.S. Cl. CPC H04N 19/40; H04N 19/149

(57) ABSTRACT

Embodiments of the present disclosure provide a method, an apparatus, a device, and a storage medium for video transcoding. The method includes: obtaining a first video to be transcoded; determining first video feature information corresponding to the first video; determining, based on the first video feature information and a predetermined decision tree regression model, a predicted play count of the first video at each of bit rate levels that are currently not transcoded; and determining a target bit rate level from the bit rate levels based on the predicted play count, and transcoding the first video based on the target bit rate level.

This application claims priority to Chinese Patent Application No. 202210572191.3, filed on May 24, 2022, the entire contents of which are incorporated herein by reference.

### FIELD

Embodiments of the present disclosure relate to computer technologies, for example, to a method, an apparatus, a device, and a storage medium for video transcoding.

### BACKGROUND

With the rapid development of computer technology, a video uploaded by a user needs to be transcoded, and the transcoded video is delivered to the playing end.

### SUMMARY

The present disclosure provides a method and an apparatus for video transcoding, a device and a storage medium.

According to a first aspect, an embodiment of the present disclosure provides a method for video transcoding, including:
obtaining a first video to be transcoded;
determining first video feature information corresponding to the first video;
determining, based on the first video feature information and a predetermined decision tree regression model, a predicted play count of the first video at each of bit rate levels that are currently not transcoded; and
determining a target bit rate level from the bit rate levels based on the predicted play count, and transcoding the first video based on the target bit rate level.

According to a second aspect, an embodiment of the present disclosure further provides an apparatus for video transcoding, including:
a first video obtaining module, configured to obtain a first video to be transcoded;
a first video feature information determining module, configured to determine first video feature information corresponding to the first video;
a predicted play count determining module, configured to determine, based on the first video feature information and a predetermined decision tree regression model, a predicted play count of the first video at each of bit rate levels that are currently not transcoded; and
a video transcoding module, configured to determine a target bit rate level from the bit rate levels based on the predicted play count, and transcoding the first video based on the target bit rate level.

According to a third aspect, an embodiment of the present disclosure further provides an electronic device, including:
one or more processors;
a storage device configured to store one or more programs, and
the one or more programs, when executed by the one or more processors, cause the one or more processors to implement a method for video transcoding according to any one of the embodiments of the present disclosure.

According to a fourth aspect, an embodiment of the present disclosure further provides a storage medium including computer executable instructions, the computer executable instructions are configured to, when executed by a computer processor, implement a method for video transcoding according to any one of the embodiments of the present disclosure.

### BRIEF DESCRIPTION OF DRAWINGS

Throughout the drawings, the same or similar reference numbers refer to the same or similar elements. It shall be understood that the drawings are illustrative, and components and elements are not necessarily drawn to scale.

FIG. 1 is a schematic flowchart of a method for video transcoding according to an embodiment of the present disclosure;

FIG. 2 is a schematic flowchart of another method for video transcoding according to an embodiment of the present disclosure;

FIG. 3 is a schematic structural diagram of an apparatus for video transcoding according to an embodiment of the present disclosure;

FIG. 4 is a schematic structural diagram of an electronic device according to an embodiment of the present disclosure.

### DETAILED DESCRIPTION

With the rapid development of computer technology, a video uploaded by a user needs to be transcoded, and the transcoded video is delivered to the playing end. Typically, each video has multiple bit rate levels. All bit rate levels of the video are transcoded to obtain videos at different bit rate levels. Therefore, the video transcoding mode consumes a lot of transcoding resources, and a large number of servers need to be set for support computility, thereby increasing cost on devices.

The embodiment of the present disclosure provides a method and an apparatus for video transcoding, a device, and a storage medium.

Embodiments of the present disclosure will be described below with reference to the accompanying drawings. It shall be understood that the various steps described in the method implementation of this disclosure can be executed in different orders and/or in parallel. In addition, the method implementation can include additional steps and/or the steps as shown may be omitted. The scope of this disclosure is not limited in this regard.

The term “including” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different devices, modules, or units, but are not used to limit the order or interdependence of the functions performed by these devices, modules, or units.

It should be noted that the modifications of “one” and “a plurality of” mentioned in this disclosure are illustrative but not limiting. Those skilled in the art should understand that unless otherwise indicated in the context, they should be understood as “one or more”.

The names of messages or information interacted between multiple devices in embodiments of the present disclosure are for illustrative purposes only and are not intended to limit the scope of such messages or information.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, a prompt message is sent to the user to explicitly prompt the user that the operation requested to be performed will require acquiring and using personal information of the user. Thus, the user can autonomously select whether to provide personal information to software or hardware such as electronic devices, applications, servers, or storage media that perform operations of the disclosed technical solution, based on the prompt message.

As an implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It may be understood that the above notification and user authorization process are only illustrative which do not limit the implementation of this disclosure. Other methods that meet relevant laws and regulations can also be applied to the implementation of this disclosure.

It can be understood that data involved in this technical solution (including but not limited to the data itself, acquisition or use of the data) should comply with the requirements of corresponding laws, regulations, and relevant provisions.

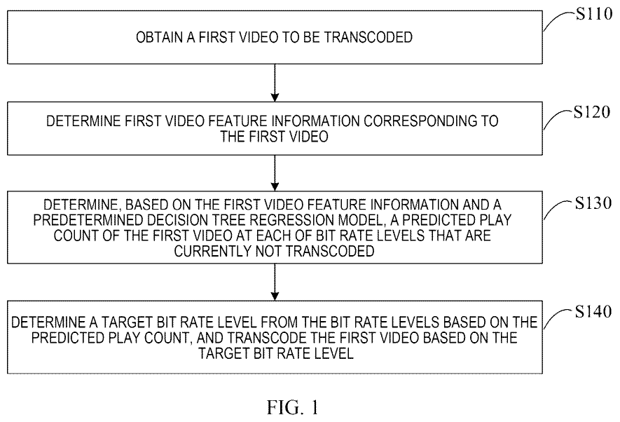

FIG. 1 is a schematic flowchart illustrating a method for video transcoding provided by an embodiment of the present disclosure. Embodiments of the present disclosure may transcode a video, and the method may be performed by an apparatus for video transcoding, which may be implemented in the form of software and/or hardware, e.g., by an electronic device, which may be a mobile terminal, a personal computer (PC) terminal, or a server, etc.

As shown in FIG. 1, the method for video transcoding includes the following steps:

At S110, a first video to be transcoded is obtained.

The first video may refer to any video that needs to be transcoded. For example, a video uploaded by a user may be used as the first video, or a video with a video play count reaching a present number may be used as the first video.

Each video has a default bit rate level. When the video is transcoded, the default bit rate level may be preferentially transcoded, so as to preferentially obtain a video at the default bit rate level, so that in the case that the video is not transcoded at other bit rate levels, the video at the default bit rate level may be delivered, to ensure that the video can always be played normally. The bit rate level for transcoding prediction in this embodiment may not include the default bit rate level. The transcoding of the default bit rate levels consumes less time and transcoding resources, which is negligible.

At S120, first video feature information corresponding to the first video is determined.

The first video feature information may refer to static feature information and dynamic feature information associated with the first video. For example, the first video feature information may include, but is not limited to, video information, uploader information, information about a current video play count, information about the number of current video viewers, and information about a current video play growth rate corresponding to the first video. The video information may refer to static feature information of the first video itself, for example, a video creation time. The uploader information may refer to author information that is set to be public by the author uploading the first video, for example, the number of days since the account was created, the total play count, the total evaluation amount, and the total number of likes of the uploaded video, etc. The information about a current video play count may refer to the number of times the first video being played at the current moment. The information about the number of current video viewers may refer to the number of users who play the first video at the current moment. The information about a current video play growth rate may refer to information about the play count growth rate obtained by counting the play counts of the first video at the current moment every predetermined time. It should be noted that, if the first video is not currently played, the information about a current video play count, the information about the number of current video viewers, and the information about a current video play growth rate corresponding to the first video may be set to empty.

For example, first video feature information corresponding to the first video at the current moment may be determined in real time.

At S130, a predicted play count of the first video at each of bit rate levels that are currently not transcoded is determined based on the first video feature information and a predetermined decision tree regression model.

The predetermined decision tree regression model may be a predetermined regression model having a decision tree architecture and configured to predict the play counts at one or more bit rate levels. The predetermined decision tree regression model may be any gradient boosting based Gradient Boosting Decision Tree (GBDT). For example, the predetermined decision tree regression model may be, but is not limited to, a Light Gradient Boosting Machine (LightGBM) regression model. The predetermined decision tree regression model used in the embodiments of the present disclosure is a model trained in advance based on sample data. The sample data may include video feature information corresponding to a sample video and an actual play count of the sample video at each bit rate level.

For example, if the predetermined decision tree regression model could predict the predicted play counts at respective bit rate levels at the same time, the first video feature information may be input into a pre-trained predetermined decision tree regression model for play count prediction; and the predicted play count of the first video at each bit rate level is obtained based on the output of the predetermined decision tree regression model; and then the predicted play count at each bit rate level that is not transcoded currently is screened out from the model output result based on each bit rate level that is not currently transcoded. Alternatively, if each bit rate level corresponds one predetermined decision regression model, a target predetermined decision regression model corresponding to each bit rate level of the first video that is not transcoded currently is screened out from respective predetermined decision regression models, and the first video feature information is input into each target predetermined decision regression model to predict the predicted play count at the corresponding bit rate level, and the predicted play count at each bit rate level that is not transcoded currently may be obtained based on the output of each target predetermined decision regression model.

At S140, a target bit rate level is determined from the bit rate levels based on the predicted play count, and the first video is transcoded based on the target bit rate level.

The target bit rate level may refer to a bit rate level with a higher value (that is, a higher importance degree) in respective bit rate levels that are not transcoded currently. The target bit rate level may be one bit rate level, or may be a plurality of bit rate levels meeting a condition.

For example, the importance degrees of respective bit rate levels may be ranked based on the predicted play counts at respective bit rate levels that are not currently transcoded, to obtain the target bit rate level with the highest importance degree. For example, a bit rate level with a predicted play count higher than a predetermined play count threshold may be used as the target bit rate level. By preferentially transcoding the target bit rate level in a case of limited transcoding resources, the first video at the target bit rate level is obtained without having to transcode all bit rate levels at one time, so that the watching experience of the user can be ensured while the transcoding resources are greatly saved, and thus the device cost is reduced. For example, if one video has 10 bit rate levels, and a previous viewing effect can be ensured by only transcoding 5 bit rate levels by means of transcoding in the embodiments of the present disclosure, thereby greatly saving transcoding resources.

For example, “determining the target bit rate level from the bit rate levels based on the predicted play count” in S140 may include: comparing the predicted play counts corresponding to respective bit rate levels, and determining a bit rate level with the highest predicted play count as the target bit rate level; or, obtaining at least one candidate bit rate level each with a predicted play count greater than or equal to a predetermined play count threshold by comparing the predetermined play count threshold with the predicted play count corresponding to each bit rate level, and determining a candidate bit rate level with the highest predicted play count as the target bit rate level.

For example, the predicted play counts can be ranked from high to low based on predicted play counts at respective bit rate levels that are not currently transcoded, and the bit rate level with the highest predicted play count is used as the target bit rate level with the highest importance degree, so that the target bit rate level with the highest predicted play count can be preferentially transcoded each time, and thus the transcoding resources are saved.

Alternatively, the predetermined play count threshold is compared with the predicted play count corresponding to each bit rate level that is not transcoded currently, a bit rate level with a predicted play count greater than or equal to the predetermined play count threshold is used as a candidate bit rate level, the predicted play counts corresponding to respective candidate bit rate levels are compared, and candidate bit rate level with the highest predicted play count is determined as the target bit rate level, thereby ensuring that the target bit rate level is the bit rate level with the highest importance degree that can be transcoded, which improves the transcoding diversity, and meeting different personalized requirements.

According to the embodiment of the present disclosure, the first video to be transcoded is obtained, the first video feature information corresponding to the first video is determined, the predicted play count of the first video at each bit rate level which is not transcoded currently is determined according to the first video feature information and the predetermined decision tree regression model, the target bit rate level is determined from all the bit rate levels based on the predicted play count, and the first video is transcoded based on the target bit rate level, so that the target bit rate level with higher predicted play count can be preferentially transcoded without having to transcode all bit rate level at one time, so that the transcoding resources are greatly saved while the user watching experience is guaranteed, and the device cost is reduced.

On the basis of the foregoing embodiment, after S140, the method may further include: if it is detected that at least two untranscoded bit rate levels currently exist for the first video, the operation of step S120 is returned to be executed in response to a predetermined transcoding trigger condition.

The predetermined transcoding trigger condition may be a trigger condition predetermined based on a service requirement and a scenario and configured for performing a transcoding operation. For example, the predetermined transcoding trigger condition may refer to a condition for triggering a transcoding operation when there are sufficient transcoding resources currently, or a condition for triggering a transcoding operation at predetermined intervals.

For example, after the first video is transcoded, whether a bit rate level that has not been transcoded currently exists in the first video may be detected in real time, and if at least two untranscoded bit rate levels currently exist, the operation of step S120 may be returned to performed when the predetermined transcoding trigger condition is met, and then the target bit rate level that is preferentially to be transcoded is determined from all the bit rate levels that are not transcoded currently, and then the target bit rate level is transcoded, so that the transcoding may be performed in sequence based on the importance degrees of the transcoding levels in the case of limited resources, thereby avoiding affecting the user's viewing experience. If there is only one bit rate level that is not transcoded currently, the bit rate level may be directly transcoded when the predetermined transcoding trigger condition is met.

On the basis of the foregoing embodiment, after S140, the method may further include: if it is detected that at least one untranscoded bit rate level currently exists for the first video, deleting the currently existing respective untranscoded bit rate levels.

For example, after the first video is transcoded, if it is detected that at least one untranscoded bit rate level currently exists for the first video, each currently existing bit rate level may be directly deleted, so that the bit rate levels are not transcoded, thereby saving transcoding resources.

It should be noted that, if there is no target bit rate level meeting the condition in S140, for example, if the predicted play count at each bit rate level that is not transcoded currently is less than the predetermined play count threshold, it indicates that the remaining untranscoded bit rate levels do not need to be transcoded, and at this time, each bit rate level that is not transcoded currently may be deleted directly, thereby saving transcoding resources while not affecting the user's viewing experience.

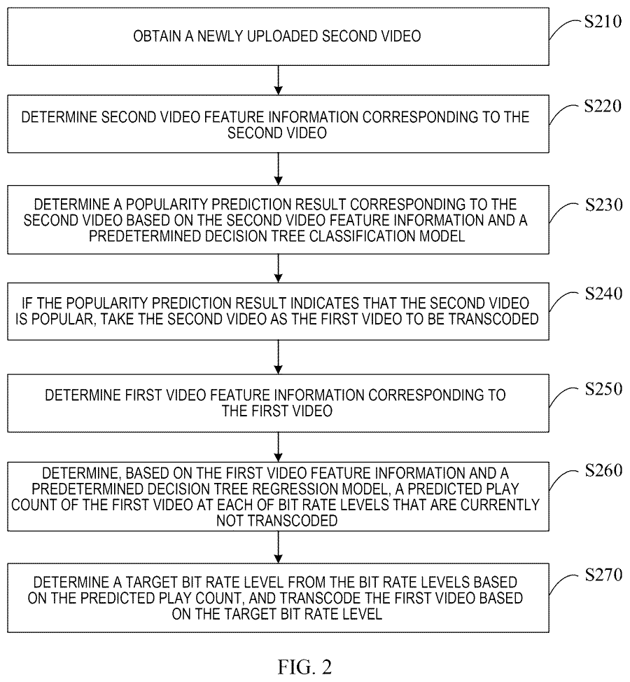

FIG. 2 is a schematic flowchart illustrating another method for video transcoding according to an embodiment of the present disclosure. The embodiment of the present disclosure adjusts the step “obtaining the first video to be transcoded” based on the above disclosure embodiment. Explanations of terms that are the same as or corresponding to the foregoing embodiments of the present disclosure are not described herein again.

As shown in FIG. 2, the method for video transcoding includes the following steps:

At S210, a newly uploaded second video is obtained.

The second video may refer to an original video currently being submitted by an author. For example, after the author creates a new second video on the terminal device, the terminal device may upload the newly created second video to a server for submission, so that the server may obtain the currently newly uploaded second video.

At S220, second video feature information corresponding to the second video is determined.

The second video feature information may refer to static feature information and dynamic feature information associated with the second video. The second video feature information may include, but is not limited to, video information corresponding to the second video, uploader information, information about an upload end hardware, and information about a current video play count. The video information may refer to static feature information of the second video itself, such as a video title, a video duration, a video length, and a width, etc. The uploader information may refer to author information that is set to be public by the author uploading the second video, for example, the number of days since the account was created, the number of fans, the number of uploaded videos, submission activity and the like. The information about an upload end hardware may refer to information of a terminal device that uploads the second video, for example, a model of the terminal device. The information about a current video play count may refer to the number of times the second video being played at the current moment. It should be noted that, if the second video is not currently played, the information about a current video play count may be set as empty

For example, the second video feature information corresponding to the second video at the current moment may be determined in real time.

At S230, a popularity prediction result corresponding to the second video is determined based on the second video feature information and a predetermined decision tree classification model.

The predetermined decision tree classification model may be a classification model predetermined and configured for performing popularity prediction on the newly uploaded second video. The predetermined decision tree classification model may be any Gradient Boosting Decision Tree (GBDT) based on gradient boosting. For example, the predetermined decision tree classification model may be, but is not limited to, an XGBOOST classification model. The predetermined decision tree classification model used in the embodiments of the present disclosure is a model trained in advance based on sample data. The sample data may include video feature information corresponding to the sample video and an actual popularity result corresponding to the sample video. The popularity prediction result may include a popular video or an unpopular video.

For example, the newly uploaded second video feature information may be input into the pre-trained predetermined decision tree classification model for performing popularity prediction when the video is uploaded, so that video popularity prediction may be performed when uploading the video, and there is no need to wait to perform video popularity prediction until the video is played, so that the transcoding operation for the popular video may be performed in advance, thus the bandwidth consumption of video transmission is reduced, and the video transmission cost is reduced. The predetermined upload popularity prediction model in the embodiments of the present disclosure may directly output the popularity prediction result corresponding to the target video, or may output a prediction probability value indicating that the target video is a popular video, and determine the final popularity prediction result based on the prediction probability value. For example, if the output prediction probability value is greater than 0.5, the popularity prediction result indicates that the second video is popular, otherwise, the second video is unpopular.

At S240, if the popularity prediction result indicates that the second video is popular, the second video is taken as the first video to be transcoded.

For example, when the popularity prediction result corresponding to the second video indicates that the second video is popular, the second video may be taken as the first video to be transcoded, so that the popular video can be preferentially predicted and transcoded, thereby ensuring the user's viewing experience.

For example, if the popularity prediction result indicates that the second video is not popular, the operation of step S220 is returned to be performed in response to the predetermined popularity prediction trigger condition. The predetermined popularity prediction trigger condition may be a trigger condition configured for performing a popularity prediction operation and predetermined based on a service requirement and a scenario. For example, the predetermined popularity prediction trigger condition may be an operation of triggering the popularity prediction operation every predetermined time.

For example, when the popularity prediction result corresponding to the second video indicates that the second video is not popular, when the predetermined popularity prediction trigger condition is met, the popularity prediction may be performed again on the second video by returning to perform the operation of step S220, until the second video is popular or the play time limit of the second video exceeds the predetermined time limit. According to the embodiment of the present disclosure, the popularity prediction can be carried out immediately after the second video is submitted, and the popularity prediction can be performed again each time the predetermined popularity prediction trigger condition is met after the video is predicted to be not popular, so that the accuracy in popularity prediction is improved.

At S250, first video feature information corresponding to the first video is determined.

It should be noted that, for the same video, when the popularity is predicted, the second video feature information focuses on more video static feature information. When a play count at a bit rate level is predicted, the first video feature information focuses more on video dynamic feature information. The number of features included in the first video feature information is greater than the number of features included in the second video feature information, so that the predicted play count at each bit rate level can be determined more accurately and quickly by using the LightGBM regression model through parallel processing.

At S260, a predicted play count of the first video at each of bit rate levels that are currently not transcoded is determined based on the first video feature information and a predetermined decision tree regression model.

At S270, a target bit rate level is determined from the bit rate levels based on the predicted play count, and the first video is transcoded based on the target bit rate level.

According to the embodiment of the present disclosure, the newly uploaded second video is obtained, the popularity prediction result corresponding to the second video is determined based on the second video feature information corresponding to the second video and the predetermined decision tree classification model, and when the popularity prediction result indicates that the second video is popular, the second video is taken as the first video to be transcoded, so that transcoding prediction can be preferentially performed on the popular video, and the user watching experience is ensured.

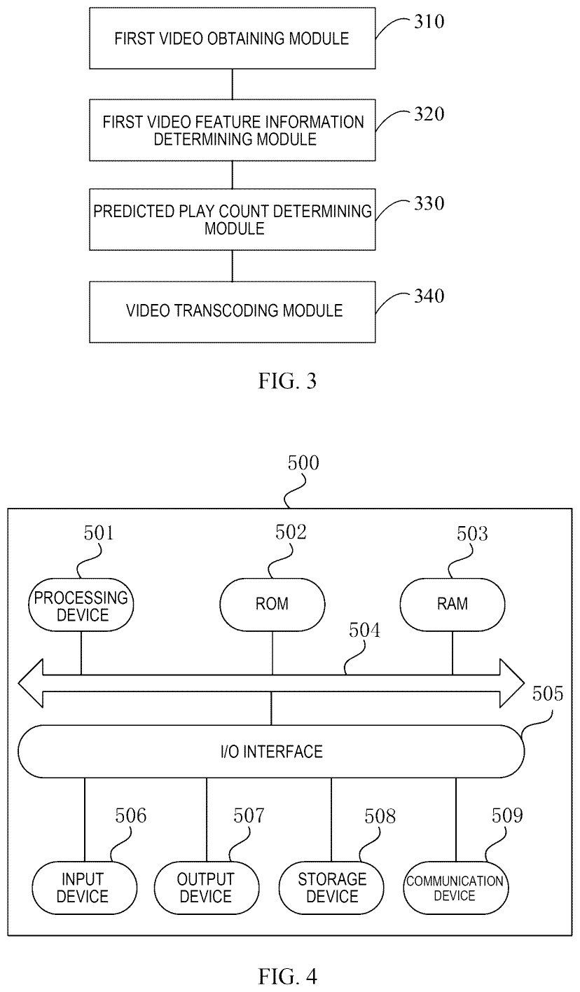

FIG. 3 is a schematic structural diagram of an apparatus for video transcoding according to an embodiment of the present disclosure. As shown in FIG. 3, the apparatus includes a first video obtaining module 310, a first video feature information determining module 320, a predicted play count determining module 330, and a video transcoding module.

The first video obtaining module 310 is configured to obtain a first video to be transcoded; the first video feature information determining module 320 is configured to determine first video feature information corresponding to the first video; the predicted play count determining module 330 is configured to determine, based on the first video feature information and a predetermined decision tree regression model, a predicted play count of the first video at each of bit rate levels that are currently not transcoded; and the video transcoding module 340 is configured to determine a target bit rate level from the bit rate levels based on the predicted play count, and transcode the first video based on the target bit rate level.

According to the embodiment of the present disclosure, the first video to be transcoded is obtained, the first video characteristic information corresponding to the first video is determined, the predicted play count of the first video in each bit rate level which is not transcoded currently is determined according to the first video feature information and the predetermined decision tree regression model, the target bit rate level is determined from all the bit rate levels based on the predicted play count, and the first video is transcoded based on the target bit rate level, so that the target bit rate level with higher predicted play count can be preferentially transcoded without having to transcode all bit rate level at one time, so that the transcoding resources are greatly saved while the user watching experience is guaranteed, and the device cost is reduced.

On the basis of the foregoing embodiments, the first video feature information includes: video information, uploader information, information about a current video play count, information about the number of current video viewers, and information about a current video play growth rate corresponding to the first video, where the predetermined decision tree regression model is a gradient boosting based decision tree regression model.

Based on the foregoing embodiments, the video transcoding module 340 is configured to:
comparing the predicted play counts corresponding to respective bit rate levels, and determining a bit rate level with the highest predicted play count as the target bit rate level; or
obtaining at least one candidate bit rate level each with a predicted play count greater than or equal to a predetermined play count threshold by comparing the predetermined play count threshold with the predicted play count corresponding to each bit rate level, and determining a candidate bit rate level with the highest predicted play count as the target bit rate level.

Based on the foregoing embodiments, the apparatus further includes:
a bit rate level processing module, configured to, after transcoding the first video based on the target bit rate level, in response to detecting that at least two untranscoded bit rate levels currently exist for the first video, return, in response to a predetermined transcoding trigger condition, to perform an operation of determining the first video feature information corresponding to the first video.

Based on the foregoing embodiments, the apparatus further includes:
a bit rate level deleting module, configured to: after transcoding the first video based on the target bit rate level, in response to detecting that at least one untranscoded bit rate level currently exists for the first video, delete the currently existing at least one untranscoded bit rate level.

Based on the foregoing embodiments, the first video obtaining module 310 is configured to:
obtain a newly uploaded second video; determine second video feature information corresponding to the second video; determine a popularity prediction result corresponding to the second video based on the second video feature information and a predetermined decision tree classification model; and in response to the popularity prediction result indicating that the second video is popular, take the second video as the first video to be transcoded.

Based on the foregoing embodiments, the second video feature information includes: video information, uploader information, information about an upload end hardware, and information about a current video play count corresponding to the second video; and the predetermined decision tree classification model is a gradient boosting based decision tree classification model.

Based on the foregoing embodiments, the apparatus further includes:
a popularity prediction processing module, configured to, in response to the popularity prediction result indicating that the second video is not popular, return, in response to a predetermined popularity prediction trigger condition, to perform an operation of determining the second video feature information corresponding to the second video.

The apparatus for video transcoding provided by the embodiments of the present disclosure may perform the method for video transcoding provided by any embodiment of the present disclosure, and has corresponding functional modules and beneficial effects for performing the method for video transcoding.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

FIG. 4 is a schematic structural diagram of an electronic device provided by an embodiment of the present disclosure. Referring to FIG. 4, it is a schematic structural diagram of an electronic device (such as the terminal device or server in FIG. 4) 500 suitable for implementing the embodiments of the present disclosure. The terminal device in the embodiments of the present disclosure may include, but is not limited to, a mobile terminal such as a mobile phone, a notebook computer, a digital broadcast receiver, a Personal Digital Assistant (PDA), a tablet computer (PAD), a Portable Multimedia Player (PMP), an in-vehicle terminal (for example, an in-vehicle navigation terminal), and a fixed terminal such as a digital Television (TV), a desktop computer, or the like. The electronic device shown in FIG. 4 is merely an example, which does not limit the function and scope of usage of the embodiments of the present disclosure.

As shown in FIG. 4, the electronic device 500 may include a processing device (for example, a central processing unit, a graphics processor, etc.) 501, which may perform various appropriate actions and processing according to a program stored in a read-only memory (ROM) 502 or a program loaded into a random-access memory (RAM) 503 from a storage device 508. In the RAM 503, various programs and data required by operation of the electronic device 500 are also stored. The processing device 501, the ROM 502, and the RAM 503 are connected to each other through a bus 504. An input/output (I/O) interface 505 is also connected to the bus 504.

Typically, the following devices can be connected to I/O interface 505: input devices 506 including, for example, touch screens, touchpads, keyboards, mice, cameras, microphones, accelerometers, gyroscopes, etc.; output devices 507 including liquid crystal displays (LCDs), speakers, vibrators, etc.; storage devices 508 including magnetic tapes, hard disks, etc.; and a communication device 509. The communication device 509 may allow the electronic device 500 to communicate with other devices wirelessly or wirelessly to exchange data. Although FIG. 4 shows an electronic device 500 with a plurality of devices, it shall be understood that it is not required to implement or have all the devices shown. More or fewer devices can be implemented or provided instead.

In particular, according to an embodiment of the present disclosure, the process described above with reference to the flowchart can be implemented as a computer software program. For example, an embodiment of the present disclosure includes a computer program product that includes a computer program carried on a non-transitory computer-readable medium, where the computer program includes program code for performing the method shown in the flowchart. In such an embodiment, the computer program can be downloaded and installed from a network through the communication device 509, or installed from the storage device 508, or installed from the ROM 502. When the computer program is executed by the processing device 501, the above functions defined in the method of the embodiment of the present disclosure are performed.

The names of messages or information interacted between multiple devices in embodiments of the present disclosure are described for illustrative purposes only and are not intended to limit the scope of such messages or information.

The electronic device provided by the embodiments of the present disclosure and the method for video transcoding provided in the foregoing embodiments belong to the same inventive concept, technical details not described in detail in this embodiment may refer to the foregoing embodiments, and this embodiment has the same beneficial effects as the foregoing embodiments.

An embodiment of the present disclosure provides a computer storage medium having a computer program stored thereon, the program, when executed by a processor, implements the method for video transcoding provided in the foregoing embodiments.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Examples of computer-readable storage media may include but are not limited to: an electrical connection with one or more wires, a portable computer disk, a hard disk, Random Access Memory (RAM), Read-Only Memory (ROM), an Erasable Programmable Read-Only Memory (EPROM) or flash memory, an optical fiber, a portable Compact Disk Read-Only Memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, radio frequency (RF), etc., or any suitable combination thereof.

In some embodiments, clients and servers can communicate using any currently known or future developed network protocol such as HTTP (Hypertext Transfer Protocol), and can be interconnected with any form or medium of digital data communication (such as communication networks). Examples of communication networks include Local Area Networks (“LANs”), Wide Area Networks (“WANs”), internetworks (such as the Internet), and end-to-end networks (such as ad hoc end-to-end networks), as well as any currently known or future developed networks.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device: obtain a first video to be transcoded; determine first video feature information corresponding to the first video; determine, based on the first video feature information and a predetermined decision tree regression model, a predicted play count of the first video at each of bit rate levels that are currently not transcoded; and determine a target bit rate level from the bit rate levels based on the predicted play count, and transcode the first video based on the target bit rate level.

The storage medium may be a non-transitory storage medium.

Computer program codes for performing the operations of the present disclosure may be written in one or more programming languages or a combination thereof, including but not limited to Object Oriented programming languages—such as Java, Smalltalk, C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including Local Area Network (LAN) or Wide Area Network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware. The name of a unit does not constitute a limitation on the unit itself in a certain case. For example, the first video obtaining module may further be described as “a unit for obtaining a first video to be transcoded”.

The functions described herein above can be performed at least in part by one or more hardware logic components. By way of example rather than limitation, example types of hardware logic components that may be used include: Field Programmable Gate Arrays (FPGAs), Application Specific Integrated Circuits (ASICs), Application Specific Standard Products (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, Random Access Memory (RAM), Read-Only Memory (ROM), an Erasable Programmable Read-Only Memory (EPROM) or flash memory, an optical fiber, a portable Compact Disk Read-Only Memory (CD-ROM), optical storage devices, magnetic storage devices, or any suitable combination thereof.

According to one or more embodiments of the present disclosure, [Example 1] provides a method for video transcoding, including:
obtaining a first video to be transcoded;
determining first video feature information corresponding to the first video;
determining, based on the first video feature information and a predetermined decision tree regression model, a predicted play count of the first video at each of bit rate levels that are currently not transcoded; and
determining a target bit rate level from the bit rate levels based on the predicted play count, and transcoding the first video based on the target bit rate level.

According to one or more embodiments of the present disclosure, [Example 2] provides a method for video transcoding, further including:
the first video feature information includes: video information, uploader information, information about a current video play count, information about the number of current video viewers, and information about a current video play growth rate corresponding to the first video; and
the predetermined decision tree regression model is a gradient boosting based decision tree regression model.

According to one or more embodiments of the present disclosure, [Example 3] provides a method for video transcoding, further including:
determining the target bit rate level from the bit rate levels based on the predicted play count includes:
comparing the predicted play counts corresponding to respective bit rate levels, and determining a bit rate level with the highest predicted play count as the target bit rate level; or
obtaining at least one candidate bit rate level each with a predicted play count greater than or equal to a predetermined play count threshold by comparing the predetermined play count threshold with the predicted play count corresponding to each bit rate level, and determining a candidate bit rate level with the highest predicted play count as the target bit rate level.

According to one or more embodiments of the present disclosure, [Example 4] provides a method for video transcoding, further including:
after transcoding the first video based on the target bit rate level, the method further includes:
in response to detecting that at least two untranscoded bit rate levels currently exist for the first video, returning, in response to a predetermined transcoding trigger condition, to perform an operation of determining the first video feature information corresponding to the first video.

According to one or more embodiments of the present disclosure, [Example 5] provides a method for video transcoding, further including:
after transcoding the first video based on the target bit rate level, the method further includes:
in response to detecting that at least one untranscoded bit rate level currently exists for the first video, deleting the currently existing at least one untranscoded bit rate level.

According to one or more embodiments of the present disclosure, [Example 6] provides a method for video transcoding, further including:
obtaining a first video to be transcoded, including
obtaining a newly uploaded second video;
determining second video feature information corresponding to the second video;
determining a popularity prediction result corresponding to the second video based on the second video feature information and a predetermined decision tree classification model; and
in response to the popularity prediction result indicating that the second video is popular, taking the second video as the first video to be transcoded.

According to one or more embodiments of the present disclosure, [Example 7] provides a method for video transcoding, further including:
the second video feature information includes: video information, uploader information, information about an upload end hardware, and information about a current video play count corresponding to the second video; and
the predetermined decision tree classification model is a gradient boosting based decision tree classification model.

According to one or more embodiments of the present disclosure, [Example 8] provides a method for video transcoding, further including:
the method further includes:
in response to the popularity prediction result indicating that the second video is not popular, returning, in response to a predetermined popularity prediction trigger condition, to perform an operation of determining the second video feature information corresponding to the second video.

According to one or more embodiments of the present disclosure, [Example 9] provides a method for video transcoding, further including:
a first video obtaining module, configured to obtain a first video to be transcoded;
a first video feature information determining module, configured to determine first video feature information corresponding to the first video;
a predicted play count determining module, configured to determine, based on the first video feature information and a predetermined decision tree regression model, a predicted play count of the first video at each of bit rate levels that are currently not transcoded; and
a video transcoding module, configured to determine a target bit rate level from the bit rate levels based on the predicted play count, and transcode the first video based on the target bit rate level.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it shall be understood that the subject matter defined in the appended claims is not necessarily limited to the specific features or actions described above. On the contrary, the specific features and actions described above are merely example forms of implementing the claims.

1-11. (canceled)

12. A method for video transcoding, comprising:
obtaining a first video to be transcoded;
determining first video feature information corresponding to the first video;
determining, based on the first video feature information and a predetermined decision tree regression model, a predicted play count of the first video at each of bit rate levels that are currently not transcoded; and
determining a target bit rate level from the bit rate levels based on the predicted play count, and transcoding the first video based on the target bit rate level.

13. The method for video transcoding of claim 12, wherein the first video feature information comprises: video information, uploader information, information about a current video play count, information about the number of current video viewers, and information about a current video play growth rate corresponding to the first video; and
the predetermined decision tree regression model is a gradient boosting based decision tree regression model.

14. The method for video transcoding of claim 12, wherein determining the target bit rate level from the bit rate levels based on the predicted play count comprises:
comparing the predicted play counts corresponding to respective bit rate levels, and determining a bit rate level with the highest predicted play count as the target bit rate level; or
obtaining at least one candidate bit rate level each with a predicted play count greater than or equal to a predetermined play count threshold by comparing the predetermined play count threshold with the predicted play count corresponding to each bit rate level, and determining a candidate bit rate level with the highest predicted play count as the target bit rate level.

15. The method for video transcoding of claim 12, further comprising: after transcoding the first video based on the target bit rate level,
in response to detecting that at least two untranscoded bit rate levels currently exist for the first video, returning, in response to a predetermined transcoding trigger condition, to perform an operation of determining the first video feature information corresponding to the first video.

16. The method for video transcoding of claim 12, further comprising: after transcoding the first video based on the target bit rate level,
in response to detecting that at least one untranscoded bit rate level currently exists for the first video, deleting the currently existing at least one untranscoded bit rate level.

17. The method for video transcoding of claim 12, wherein obtaining the first video to be transcoded comprises:
obtaining a newly uploaded second video;
determining second video feature information corresponding to the second video;
determining a popularity prediction result corresponding to the second video based on the second video feature information and a predetermined decision tree classification model; and
in response to the popularity prediction result indicating that the second video is popular, taking the second video as the first video to be transcoded.

18. The method for video transcoding of claim 17, wherein the second video feature information comprises: video information, uploader information, information about an upload end hardware, and information about a current video play count corresponding to the second video; and
the predetermined decision tree classification model is a gradient boosting based decision tree classification model.

19. The method for video transcoding of claim 17, further comprising:
in response to the popularity prediction result indicating that the second video is not popular, returning, in response to a predetermined popularity prediction trigger condition, to perform an operation of determining the second video feature information corresponding to the second video.

20. An electronic device, comprising:
one or more processors; and
a storage device configured to store one or more programs,
wherein the one or more programs, when executed by the one or more processors, cause the one or more processors to perform acts comprising:
obtaining a first video to be transcoded;
determining first video feature information corresponding to the first video;
determining, based on the first video feature information and a predetermined decision tree regression model, a predicted play count of the first video at each of bit rate levels that are currently not transcoded; and
determining a target bit rate level from the bit rate levels based on the predicted play count, and transcoding the first video based on the target bit rate level.

21. The electronic device of claim 20, wherein the first video feature information comprises: video information, uploader information, information about a current video play count, information about the number of current video viewers, and information about a current video play growth rate corresponding to the first video; and
the predetermined decision tree regression model is a gradient boosting based decision tree regression model.

22. The electronic device of claim 20, wherein determining the target bit rate level from the bit rate levels based on the predicted play count comprises:
comparing the predicted play counts corresponding to respective bit rate levels, and determining a bit rate level with the highest predicted play count as the target bit rate level; or
obtaining at least one candidate bit rate level each with a predicted play count greater than or equal to a predetermined play count threshold by comparing the predetermined play count threshold with the predicted play count corresponding to each bit rate level, and determining a candidate bit rate level with the highest predicted play count as the target bit rate level.

23. The electronic device of claim 20, wherein the acts further comprise: after transcoding the first video based on the target bit rate level,
in response to detecting that at least two untranscoded bit rate levels currently exist for the first video, returning, in response to a predetermined transcoding trigger condition, to perform an operation of determining the first video feature information corresponding to the first video.

24. The electronic device of claim 20, wherein the acts further comprise: after transcoding the first video based on the target bit rate level,
in response to detecting that at least one untranscoded bit rate level currently exists for the first video, deleting the currently existing at least one untranscoded bit rate level.

25. The electronic device of claim 20, wherein obtaining the first video to be transcoded comprises:
obtaining a newly uploaded second video;
determining second video feature information corresponding to the second video;
determining a popularity prediction result corresponding to the second video based on the second video feature information and a predetermined decision tree classification model; and
in response to the popularity prediction result indicating that the second video is popular, taking the second video as the first video to be transcoded.

26. The electronic device of claim 25, wherein the second video feature information comprises: video information, uploader information, information about an upload end hardware, and information about a current video play count corresponding to the second video; and
the predetermined decision tree classification model is a gradient boosting based decision tree classification model.

27. The electronic device of claim 25, wherein the acts further comprise:
in response to the popularity prediction result indicating that the second video is not popular, returning, in response to a predetermined popularity prediction trigger condition, to perform an operation of determining the second video feature information corresponding to the second video.

28. A non-transitory storage medium comprising computer executable instructions, wherein the computer executable instructions, when executed by a computer processor, cause the computer processor to perform acts comprising:
obtaining a first video to be transcoded;
determining first video feature information corresponding to the first video;
determining, based on the first video feature information and a predetermined decision tree regression model, a predicted play count of the first video at each of bit rate levels that are currently not transcoded; and
determining a target bit rate level from the bit rate levels based on the predicted play count, and transcoding the first video based on the target bit rate level.

29. The non-transitory storage medium of claim 28, wherein the first video feature information comprises: video information, uploader information, information about a current video play count, information about the number of current video viewers, and information about a current video play growth rate corresponding to the first video; and
the predetermined decision tree regression model is a gradient boosting based decision tree regression model.

30. The non-transitory storage medium of claim 28, wherein determining the target bit rate level from the bit rate levels based on the predicted play count comprises:
comparing the predicted play counts corresponding to respective bit rate levels, and determining a bit rate level with the highest predicted play count as the target bit rate level; or
obtaining at least one candidate bit rate level each with a predicted play count greater than or equal to a predetermined play count threshold by comparing the predetermined play count threshold with the predicted play count corresponding to each bit rate level, and determining a candidate bit rate level with the highest predicted play count as the target bit rate level.

31. The non-transitory storage medium of claim 28, wherein the acts further comprise: after transcoding the first video based on the target bit rate level,
in response to detecting that at least two untranscoded bit rate levels currently exist for the first video, returning, in response to a predetermined transcoding trigger condition, to perform an operation of determining the first video feature information corresponding to the first video.
